(19) United States
(12) Patent Application Publication
(10) Pub. No.: US 2022/0056858 A1
(43) Pub. Date: Feb. 24, 2022

(54) APPARATUS FOR CONTROLLING FUEL PUMP OF HYBRID ELECTRIC VEHICLE

(71) Applicants: Hyundai Motor Company, Seoul (KR); Kia Corporation, Seoul (KR)

(72) Inventors: Bu Yeol RYU, Hwaseong-si (KR); Hyun Do JEON, Seoul (KR); Tac Koon KIM, Seoul (KR); Bo Sung LEE, Hwaseong-si (KR)

(73) Assignees: Hyundai Motor Company, Seoul (KR); Kia Corporation, Seoul (KR)

(21) Appl. No.: 17/237,817

(22) Filed: Apr. 22, 2021

(30) Foreign Application Priority Data
Aug. 19, 2020 (KR) 10-2020-0103919

(51) Int. Cl. F02D 33/00; B60W 20/40; B60W 10/06; B60W 10/08

(52) U.S. Cl. CPC F02D 33/006; B60W 10/08; B60W 10/06; B60W 20/40

(57) ABSTRACT

An apparatus of controlling a fuel pump of a hybrid electric vehicle may which prevents frequent on/off operation of a fuel pump relay configured to control connection between a fuel pump controller and a power supply and ensures the durability of the fuel pump relay.

### CROSS-REFERENCE TO RELATED APPLICATION

The present application claims priority to Korean Patent Application No. 10-2020-0103919 filed on Aug. 19, 2020, the entire contents of which is incorporated herein for all purposes by this reference.

### BACKGROUND OF THE INVENTION

### Field of the Invention

The present invention relates to an apparatus of controlling a fuel pump of a hybrid electric vehicle. More particularly, the present invention relates to an apparatus of controlling a fuel pump of a hybrid electric vehicle which prevents frequent on/off operation of a fuel pump relay configured to control connection between a fuel pump controller and a power supply and ensures the durability of the fuel pump relay.

### Description of Related Art

In general, a hybrid electric vehicle has a fuel pump controller mounted therein to increase fuel efficiency, and an engine controller controls operation of a fuel pump relay to turn on or off the fuel pump of the hybrid electric vehicle. The fuel pump relay is configured to control electrical connection between the fuel pump controller and a power supply.

In a conventional hybrid electric vehicle, when the engine stops, the engine controller turns off the fuel pump relay, and accordingly, supply of power to the fuel pump controller is stopped and thus the fuel pump is turned off.

In general, the engine is frequently turned on or off to increase fuel efficiency while driving, causing frequent on/off operation of the fuel pump relay to control operation of the fuel pump and thus lowering the durability of the fuel pump relay.

Furthermore, the fuel pump controller employs a capacitor having high capacity to cope with electromagnetic interference (EMI) and electromagnetic compatibility (EMC). When the present fuel pump controller is turned on, inrush current momentarily occurs due to charging of the capacitor.

The inrush current of the fuel pump controller is much higher than current flowing when the fuel pump is operated normally and current flowing when a fuel pump motor is started, thus having a negative influence on the durability of the fuel pump relay.

These characteristics of the fuel pump controller not only lowers the durability of the fuel pump relay but also damages the fuel pump relay. In more detail, the fuel pump relay is damaged due to damage to a contact portion thereof, causing continuous operation of the fuel pump and discharge of a battery and consequently causing start failure.

The information disclosed in this Background of the Invention section is only for enhancement of understanding of the general background of the invention and may not be taken as an acknowledgement or any form of suggestion that this information forms the prior art already known to a person skilled in the art.

### BRIEF SUMMARY

Various aspects of the present invention are directed to providing an apparatus of controlling a fuel pump of a hybrid electric vehicle which allows a fuel pump controller to directly control a fuel pump after starting an engine to prevent frequent on/off operation of a fuel pump relay configured to control connection between the fuel pump controller and a power supply and to ensure the durability of the fuel pump relay.

Various aspects of the present invention are directed to providing an apparatus of controlling a fuel pump of a hybrid electric vehicle using an engine and a motor as driving power sources, the apparatus including a fuel pump including a fuel pump motor and configured to supply fuel to the engine by operation of a fuel pump motor, an engine controller configured to turn on a fuel pump relay configured to control connection between the fuel pump motor and a power supply when the engine is started, and a fuel pump controller configured to be turned on by electric power received from the power supply when the fuel pump relay is turned on, and to stop operation of the fuel pump by stopping supply of electric power applied to the fuel pump motor when the engine is stopped after starting the engine.

In various exemplary embodiments of the present invention, when the fuel pump controller stops the supply of the electric power applied to the fuel pump motor, the fuel pump relay may maintain an on-state thereof. When the engine is turned off, the fuel pump relay may be turned off by the engine controller. That is, the engine controller may turn off the fuel pump relay when the engine is turned off.

In another exemplary embodiment of the present invention, the fuel pump controller may forcibly drive the fuel pump configured for a predetermined time period, when an accumulated driving distance of the vehicle after starting the engine is less than or equal to a predetermined threshold distance, and control a pressure of a fuel discharged from the fuel pump so that an actually measured fuel pressure in a fuel line configured to connect the fuel pump and the engine follows a target fuel pressure, when the accumulated driving distance of the vehicle after starting the engine exceeds the threshold distance.

In various exemplary embodiments of the present invention, the fuel pump controller may drive or stop the fuel pump by controlling the electric power applied to the fuel pump motor based on engine status information received from the engine controller after starting the engine.

In various exemplary embodiments of the present invention, when the hybrid electric vehicle enters an electric vehicle mode, in which the engine is stopped and the motor alone is driven as the driving power source, after starting the engine, the fuel pump controller may stop operation of the fuel pump after a predetermine time elapses.

In still various exemplary embodiments of the present invention, the fuel pump controller may be configured to control a pressure of a fuel discharged from the fuel pump to a predetermined reference pressure value, when the engine status information or target fuel pressure information is not received from the engine controller while the hybrid electric vehicle is being driven in the electric vehicle mode.

In another exemplary embodiment of the present invention, the fuel pump controller may drive the fuel pump, when a residual pressure in a fuel line configured to connect the fuel pump and the engine is less than a predetermined threshold pressure while the hybrid electric vehicle is driven in the electric vehicle mode.

In another further embodiment, the fuel pump controller may operate the fuel pump by applying electric power to the fuel pump motor, when the engine transitions from a stop mode to a non-stop mode.

In yet another further embodiment, the fuel pump controller may be configured to control a pressure of a fuel discharged from the fuel pump to a predetermined reference pressure value, until the engine status information is received from the engine controller while the engine is being driven.

Other aspects and embodiments of the present invention are discussed infra.

The above and other features of the present invention are discussed infra.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a circuit diagram illustrating an apparatus of controlling a fuel pump of a hybrid electric vehicle according to various exemplary embodiments of the present invention;

FIG. 2 is an exemplary view exemplarily illustrating the operating states of a fuel pump relay and the fuel pump according to various exemplary embodiments of the present invention;

FIG. 3 and FIG. 4 are graphs showing a method for controlling the pressure of fuel in the apparatus according to various exemplary embodiments of the present invention; and

FIG. 5 is a flowchart showing a method for controlling a fuel pump according to various exemplary embodiments of the present invention.

It may be understood that the appended drawings are not necessarily to scale, presenting a somewhat simplified representation of various exemplary features illustrative of the basic principles of the present invention. The specific design features of the present invention as included herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the present invention(s) will be described in conjunction with exemplary embodiments of the present invention, it will be understood that the present description is not intended to limit the present invention(s) to those exemplary embodiments. On the other hand, the present invention(s) is/are intended to cover not only the exemplary embodiments of the present invention, but also various alternatives, modifications, equivalents and other embodiments, which may be included within the spirit and scope of the present invention as defined by the appended claims.

Hereinafter reference will be made in detail to various embodiments of the present invention, examples of which are illustrated in the accompanying drawings and described below. While the present invention will be described in conjunction with exemplary embodiments of the present invention, it will be understood that the present description is not intended to limit the present invention to the exemplary embodiments. On the other hand, the present invention is directed to cover not only the exemplary embodiments of the present invention, but also various alternatives, modifications, equivalents and other embodiments, which may be within the spirit and scope of the present invention as defined by the appended claims.

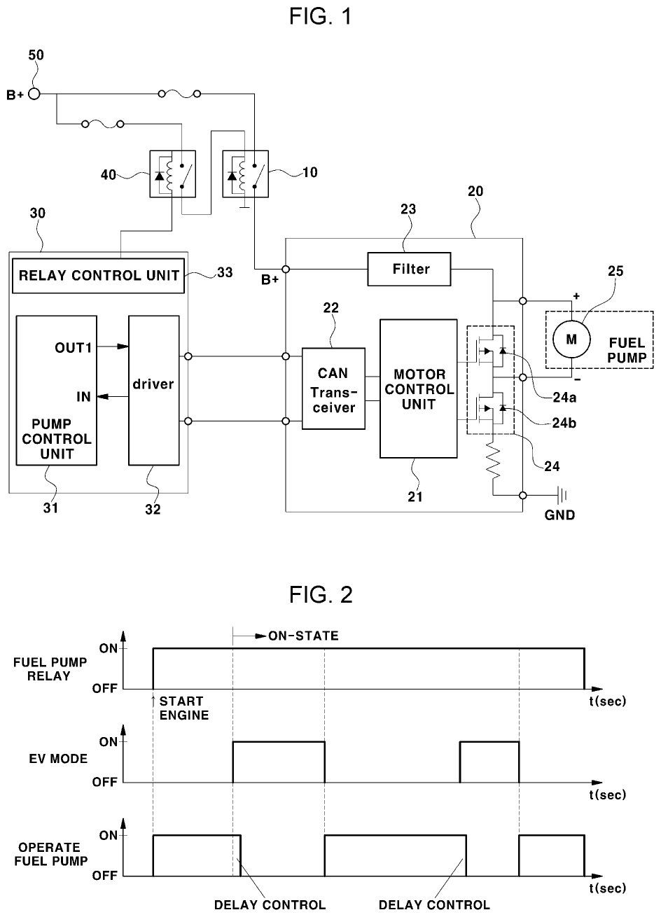

FIG. 1 is a circuit diagram illustrating an apparatus of controlling a fuel pump of a hybrid electric vehicle according to various exemplary embodiments of the present invention, and FIG. 2 is an exemplary view exemplarily illustrating the operating states of a fuel pump relay and the fuel pump according to various exemplary embodiments of the present invention.

The apparatus according to various exemplary embodiments of the present invention is an apparatus of controlling the fuel pump of the hybrid electric vehicle using an engine and a driving motor as driving power sources, and the apparatus includes, as shown in FIG. 1, an engine controller 30 configured to turn a fuel pump relay 10 on when the engine is started, and a fuel pump controller 20 configured to be turned on by power received from a vehicle power supply 50 when the fuel pump relay 10 is turned on.

The power supply 50 may be a battery which supplies driving power to a fuel pump motor 25 to enable the fuel pump to perform a fuel-pumping operation when the fuel pump relay 10 is turned on. The fuel pump is configured to pump the fuel to the engine upon operation of the fuel pump motor 25.

The fuel pump relay 10 and the fuel pump motor 25 may be connected through a filter 23. The filter 23 is configured to remove a noise component from electric power supplied to the fuel pump motor 25.

The engine controller 30 includes a relay control unit 33 configured to control operation of a control relay 40, and a pump control unit 31 configured to supply engine status information and target fuel pressure information to the fuel pump controller 20. The control relay 40 is a relay configured to control the on/off operation of the fuel pump relay 10.

The engine controller 30 may transmit the engine status information and the target fuel pressure information to the fuel pump controller 20 through a driver 32.

The fuel pump controller 20 includes a motor control unit 21 configured to control operation of the fuel pump motor 25 based on information transmitted from the pump control unit 31, a CAN transceiver 22 configured to perform communication between the motor control unit 21 and the pump control unit 31, and the filter 23.

The motor control unit 21 may control operation of a switching module 24 connected to the fuel pump relay 10 in series, and thus, conductively connect the fuel pump motor 25 and the power supply 50 or interrupt connection between the fuel pump motor 25 and the power supply 50.

The switching module 24 may include a first switching element 24a and a second switching element 24b, which are connected to each other in series. The fuel pump motor 25 may be connected to the first switching element 24a or the second switching element 24b in parallel.

For example, the fuel pump motor 25 may be connected to the first switching element 24a in parallel. In the instant case, when the first switching element 24a is turned off and the second switching element 24b is turned on, electric power is supplied to the fuel pump motor 25, and when both the first switching element 24a and the second switching element 24b are turned on, supply of electric power to the fuel pump motor 25 is stopped.

The fuel pump controller 20 controls on/off operation of the fuel pump motor 25 based on the engine status information transmitted from the engine controller 30 after starting the engine. That is, the fuel pump controller 20 drives or stops the fuel pump motor 25 depending on the status of the engine after starting the engine.

In more detail, the fuel pump controller 20 stops operation of the fuel pump by stopping supply of electric power of the power supply 50 applied to the fuel pump motor 25 when the engine is stopped after starting the engine.

When the engine is stopped after starting the engine, the engine controller 30 does not turn off the fuel pump relay 10. That is to say, when the fuel pump controller 20 cuts off electric power supplied to the fuel pump motor 25, the on-state of the fuel pump relay 10 is maintained. The engine controller 30 turns off the fuel pump relay 10 when the engine is turned off.

For example, when the hybrid electric vehicle is driven in the electric vehicle (EV) mode, the engine is stopped. When the hybrid electric vehicle is driven in the EV mode, the hybrid electric vehicle is driven using power of the motor alone among the engine and the motor. That is, when the hybrid electric vehicle enters the EV mode, the engine is stopped and the motor alone is driven.

Referring to FIG. 2, the fuel pump relay 10 is turned on by the engine controller 30 when the engine is started, and then maintains the on-state thereof before the engine is turned off, and if the vehicle enters the EV mode and the engine is stopped, the fuel pump relay 10 maintains the on-state thereof even when the operation of the fuel pump is stopped.

Therefore, the fuel pump controller 20 may continuously monitor the operating state of the fuel pump even in the EV mode in which the engine is stopped, thus being advantageous in terms of control of the fuel pressure in the fuel pump.

Furthermore, when the vehicle enters the EV mode and the engine is stopped, to maintain the residual pressure in a fuel line for connecting the engine and the fuel pump, the fuel pump may be stopped after a designated time elapses.

For the present purpose, to maintain the residual pressure in the fuel line at a designated pressure or higher when the engine transitions to the stopped state and thus driving of the engine is stopped, the fuel pump controller 20 stops operation of the fuel pump motor 25 after a predetermined time period (for example, about 0.5 seconds) elapses.

Furthermore, the fuel pump controller 20 forcibly drives the fuel pump motor 25 for a predetermined time period (for example, about 2 seconds) to increase the pressure of the fuel in the fuel line for connecting the fuel pump and the engine and the pressure of the fuel supplied from the fuel pump to the engine in an initial stage, in which the engine is started, to a predetermined reference pressure (for example, 5 bar).

Furthermore, when the accumulated driving distance of the vehicle is less than or equal to a predetermined threshold distance, the fuel pump controller 20 forcibly drives the fuel pump motor 25 for a predetermined time period (for example, about 30 seconds).

In more detail, when the accumulated driving distance of the vehicle is less than or equal to the threshold distance, the fuel pump controller 20 determines that the hybrid electric vehicle is in the initial stage, in which the engine is started, and forcibly drives the fuel pump motor 25 for the predetermined time period to remove air from the fuel line.

The threshold distance may be set to a distance value at which it is determined that the vehicle is in a vehicle assembly factory or is shipped from the factory. For example, the threshold distance may be set to 5 km or a distance value of about 5 km.

When the accumulated driving distance exceeds the threshold distance, the fuel pump controller 20 variably controls the pressure of the fuel discharged from the fuel pump so that an actually measured fuel pressure follows a target fuel pressure. The fuel pump controller 20 may control the fuel pressure of the fuel pump (i.e., the pressure of the fuel discharged from the fuel pump) by controlling operation of the fuel pump motor 25.

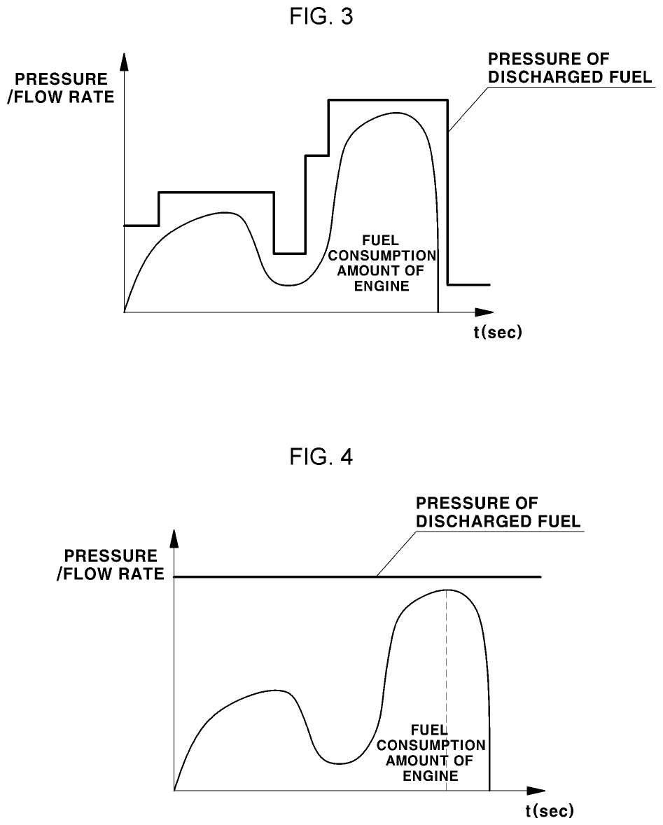

Referring to FIG. 3, the fuel pump may variably control the pressure of the fuel and the flow rate of the fuel discharged from the fuel pump by following the fuel consumption amount of the engine. The pressure of the fuel discharged from the fuel pump may be variably controlled depending on the status of the engine, and the flow rate of the fuel discharged from the fuel pump may be variably controlled depending on the actual fuel consumption amount and the safe flow rate of the engine. The safe flow rate may be set to a designated rate determined in consideration of the actual fuel consumption amount.

Control may be performed to feed back the pressure of the fuel discharged from the fuel pump so that the actually measured fuel pressure in the fuel line follows the target fuel pressure of the engine controller 30. That is, control may be performed to feed back the speed of the fuel pump motor 25 so that the actually measured fuel pressure in the fuel line follows the target fuel pressure of the engine controller 30.

The actually measured fuel pressure is a fuel pressure value, which is actually measured at the fuel line, indicating the pressure of the fuel discharged from the fuel pump to the engine. The actually measured fuel pressure may be detected through a pressure sensor provided in the fuel line for connecting the fuel pump and the engine. Furthermore, the target fuel pressure is a fuel pressure value which is set by the engine controller 30 based on the engine operation conditions.

The fuel pump controller 20 controls electric power applied to the fuel pump motor 25 based on the engine status information and the target fuel pressure information after starting the engine, thus controlling operation of the fuel pump.

When the engine transitions to a stop mode, the fuel pump controller 20 stops operation of the fuel pump motor 25 after a predetermined reference time elapses.

If the engine status information or the target fuel pressure information is not received from the engine controller 30 when the engine transitions to the stop mode and thus the vehicle is being driven in the EV mode, it may be determined that a communication timeout error has occurred between the engine controller 30 and the fuel pump controller 20.

If the engine status information or the target fuel pressure information is not received while the vehicle is being driven in the EV mode, the fuel pump controller 20 may not detect re-driving of the engine in real time.

Therefore, if the engine status information or the target fuel pressure information is not received from the engine controller 30, the fuel pump controller 20 limits and controls the pressure of the fuel discharged from the fuel pump to a predetermined reference pressure value (for example, 5 bar). In other words, until the engine status information or the target fuel pressure information is received from the engine controller 30, the fuel pump controller 20 limits and controls the pressure of the fuel discharged from the fuel pump to the reference pressure value.

The reference pressure value may be set to a pressure value deduced through preliminary experimentation, evaluation, etc., based on the severe operation conditions of the fuel pump.

Furthermore, the fuel pump controller 20 may monitor the residual pressure in the fuel line while the vehicle is being driven in the EV mode, and when the residual pressure in the fuel line is less than a predetermined threshold pressure, apply electric power to the fuel pump motor 25 to drive the fuel pump until the residual pressure in the fuel line becomes equal to or greater than the predetermined threshold pressure.

Furthermore, the fuel pump controller 20, when the engine transitions from the stop mode to a non-stop mode, applies electric power to the fuel pump motor 25 to drive the fuel pump.

The non-stop mode denotes the engine status rather than the stop mode. In more detail, the non-stop mode may be any one of a start mode, an idle speed mode, a partial load mode, a full load mode and a fuel cutoff mode.

Concretely, the start mode corresponds to a state in which the engine is rotated to be started when power greater than the driving power of the driving mode is required while the vehicle is being driven in the EV mode. The idle-speed mode corresponds to a state in which the engine is driven at an idle rotation speed (RPM) out of need, i.e., to increase the temperature of cooling water, to heat the interior of the vehicle, or to maintain the state of the engine, unrelated to the EV mode and driver's demanded power. The partial load mode corresponds to a state in which the driver's demanded power, determined by the extent to which an accelerator pedal is depressed, is satisfied by the power of the driving motor and the power of the engine. That is, the partial load mode corresponds to a state in which both the engine and the driving motor are driven. The full load mode corresponds to a state in which 100% of the power of the engine and the power of the driving motor is used. For example, if the accelerator pedal is depressed fully, that is, the open value of the accelerator pedal is 100%, the vehicle is driven in the full load mode. The fuel cutoff mode corresponds to a state in which fuel supply to the engine is cut off.

Furthermore, if engine status information is not received from the engine controller 30 while the engine is being driven in a non-stop mode, the fuel pump controller 20 fixes and controls the pressure of the fuel discharged from the fuel pump to the reference pressure value (for example, 5 bar). In other words, until the engine status information is received from the engine controller 30, the fuel pump controller 20 limits and controls the pressure of the fuel discharged from the fuel pump to the reference pressure value.

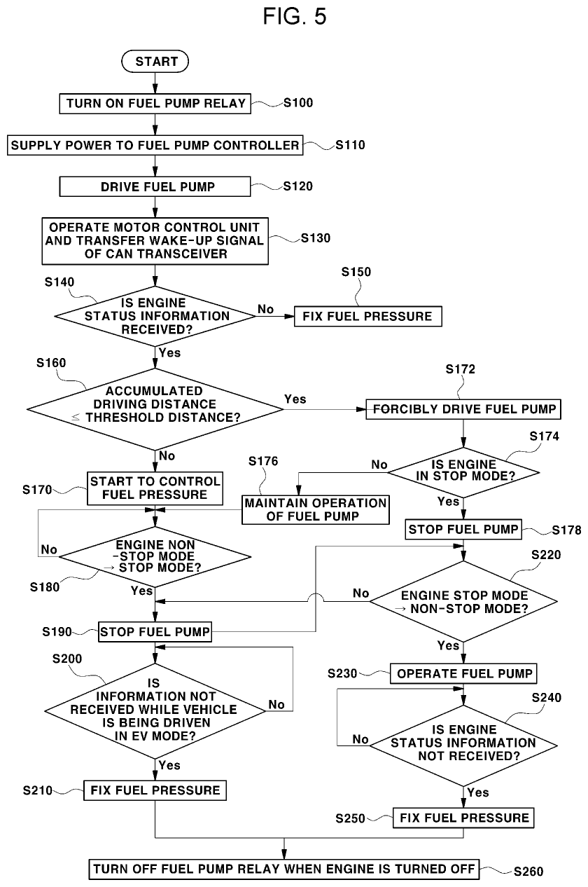

Hereinafter, referring to FIG. 5, a method for controlling the fuel pump of the hybrid electric vehicle will be described by way of example. Here, it will be understood that the method is not limited to the flowchart shown in FIG. 5.

As shown in FIG. 5, when the engine controller 30 operates the fuel pump relay 10 (S100), the power supply 50 is connected to the fuel pump controller 20 so that electric power is supplied to the fuel pump controller 20 (S110).

The fuel pump controller 20 drives the fuel pump by applying electric power to the fuel pump motor 25 by operating the switching module 24 for a designated time before the fuel pump controller 20 starts communication with the engine controller 30 in the initial stage, in which the fuel pump controller 20 is connected to the power supply 50 through the fuel pump relay 10 (S120). Here, the fuel pump is driven at a predetermined pressure value (for example, 5 bar).

When the motor controller 21 starts to be operated by electric power received from the power supply 50, the fuel pump motor 25 is controlled by the motor controller 21.

When the motor controller 21 is operated by the electric power, the motor controller 21 transmits the wake-up signal of the CAN transceiver 22 to the engine controller 30 (S130), and determines whether or not engine status information and target fuel pressure information are received from the pump control unit 31 of the engine controller 30 (S140).

When the engine controller 30 receives the wake-up signal of the CAN transceiver 22, the engine controller 30 recognizes that the engine controller 30 is in a state in which communication with the motor control unit 21 is possible, and transmits the engine status information or the target fuel pressure information to the motor control unit 21 of the fuel pump controller 20.

When the motor control unit 21 does not receive the engine status information or the target fuel pressure information within a designated time, the motor control unit 21 fixes and controls the pressure of the fuel discharged from the fuel pump to a predetermined reference pressure value (for example, 5 bar) (S150).

Alternatively, upon determining that the motor control unit 21 normally receives the engine status information or the target fuel pressure information, the engine controller 30 compares accumulated driving distance information received from an odometer with threshold distance information (for example, 5 km), which is stored in advance (S160).

The engine controller 30 transmits a result of comparison between the accumulated driving distance and the threshold distance information to the motor control unit 21. The engine controller 30 may transmit information indicating whether or not the hybrid electric vehicle is in the initial stage, in which the engine is started, instead of the result of comparison between the accumulated driving distance and the threshold distance information.

When the motor control unit 21 recognizes that the accumulated driving distance exceeds the threshold distance, the motor control unit 21 starts variable pressure control of the fuel pump by operating the fuel pump motor 25 (S170).

During operation of the fuel pump motor 25, the engine controller 30 determines whether or not the engine transitions from the non-stop mode to the stop mode (S180).

When the engine transitions from the non-stop mode to the stop mode, the fuel pump controller 20 stops the fuel pump motor 25 after a predetermined time period (for example, 0.52 seconds) elapses (S190).

Accordingly, when the engine transitions to the stop mode and thus the vehicle is being driven in the EV mode, the fuel pump controller 20 determines whether or not engine status information or target fuel pressure information is received normally (S200).

When the engine status information or the target fuel pressure information is not received, the fuel pump controller 20 fixes and controls the pressure of the fuel discharged from the fuel pump to the reference pressure value (for example, 5 bar) (S210).

When the engine status information or the target fuel pressure information is not received, the fuel pump controller 20 may conclude that the engine status information or the target fuel pressure information is not received due to communication timeout or an error of reception of information through the CAN transceiver 22 caused by abnormality of connection of the CAN transceiver 22.

Furthermore, when the engine transitions to the stop mode and thus the vehicle is being driven in the EV mode, the fuel pump controller 20 determines whether or not the engine transitions from the stop mode to the non-stop mode (S220). When the engine transitions from the stop mode to the non-stop mode, the fuel pump controller 20 operates the fuel pump again to drive the engine (S230).

When the engine transitions to the non-stop mode and thus the vehicle is being driven in an engine driving mode, the fuel pump controller 20 determines whether or not the engine status information or the target fuel pressure information is received normally (S240).

If the fuel pump controller 20 does not receive the engine status information or the target fuel pressure information from the engine controller 30 due to CAN communication timeout or the like, the fuel pump controller 20 is not configured for normally controlling the fuel pump, and thus controls the pressure of the fuel discharged from the fuel pump to the reference pressure value (for example, 5 bar) (S250).

When the engine is turned off during control of the fuel pump, the engine controller 30 turns off the fuel pump relay 10 (S260).

Upon recognizing that the accumulated driving distance is less than or equal to the threshold distance in Operation S160, the motor control unit 21 forcibly drives the fuel pump motor 25 for a predetermined time period (for example, 30 seconds) to remove air from the fuel line (S172).

Thereafter, the motor control unit 21 determines whether or not the engine is in the stop mode based on information received from the engine controller 30 (S174). Upon determining that the engine is in the non-stop mode, the motor control unit 21 maintains operation of the fuel pump motor 25 which is being forcibly driven (S176).

On the other hand, when the engine transitions from the non-stop mode to the stop-mode and thus the vehicle enters the EV mode (S180), the fuel pump controller 20 stops the fuel pump (S190) and determines whether or not the engine status information or the target fuel pressure information is received normally (S200).

When the engine status information or the target fuel pressure information is not received, the fuel pump controller 20 fixes and controls the pressure of the fuel discharged from the fuel pump to the reference pressure value (for example, 5 bar) (S210).

Upon determining that the engine is in the stop mode in Operation S174, the motor controller 21 stops operation of the fuel pump by stopping power supply to the fuel pump motor 25 which is being forcibly driven (S178).

Thereafter, the motor control unit 21 determines whether or not the engine transitions from the stop mode to the non-stop mode based on the information received from the engine controller 30 (S220).

When the engine transitions from the stop mode to the non-stop mode, the fuel pump controller 20 operates the fuel pump again by applying electric power to the fuel pump motor 25 (S230).

If the fuel pump controller 20 does not receive the engine status information or the target fuel pressure information from the engine controller 30 when the engine transitions to the non-stop mode and thus the vehicle is being driven in the engine driving mode, the fuel pump controller 20 fixes and controls the pressure of the fuel discharged from the fuel pump to the reference pressure value (for example, 5 bar) (S250).

When the engine is turned off during control of the fuel pump, the engine controller 30 turns off the fuel pump relay 10 (S260).

As is apparent from the above description, an apparatus of controlling a fuel pump of a hybrid electric vehicle according to various exemplary embodiments of the present invention enables a fuel pump controller to directly drive or stop a fuel pump before an engine is turned off after starting the engine to prevent frequent on/off operation of a fuel pump relay depending on the status of the engine and thus to ensure the durability of the fuel pump relay.

Furthermore, the term related to a control device such as “controller”, “control unit”, “control device” or “control module”, etc refers to a hardware device including a memory and a processor configured to execute one or more steps interpreted as an algorithm structure. The memory stores algorithm steps, and the processor executes the algorithm steps to perform one or more processes of a method in accordance with various exemplary embodiments of the present invention. The controller according to exemplary embodiments of the present invention may be implemented through a nonvolatile memory configured to store algorithms for controlling operation of various components of a vehicle or data about software commands for executing the algorithms, and a processor configured to perform operation to be described above using the data stored in the memory. The memory and the processor may be individual chips. Alternatively, the memory and the processor may be integrated in a single chip. The processor may be implemented as one or more processors. The processor may include various logic circuits and operation circuits, may process data according to a program provided from the memory, and may generate a control signal according to the processing result.

The control device may be at least one microprocessor operated by a predetermined program which may include a series of commands for carrying out the method included in the aforementioned various exemplary embodiments of the present invention.

The aforementioned invention can also be embodied as computer readable codes on a computer readable recording medium. The computer readable recording medium is any data storage device that can store data which may be thereafter read by a computer system. Examples of the computer readable recording medium include hard disk drive (HDD), solid state disk (SSD), silicon disk drive (SDD), read-only memory (ROM), random-access memory (RAM), CD-ROMs, magnetic tapes, floppy discs, optical data storage devices, etc and implementation as carrier waves (e.g., transmission over the Internet).

In various exemplary embodiments of the present invention, each operation described above may be performed by a controller, and the controller may be configured by a plurality of controllers, or an integrated single controller.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The foregoing descriptions of specific exemplary embodiments of the present invention have been presented for purposes of illustration and description. They are not intended to be exhaustive or to limit the present invention to the precise forms disclosed, and obviously many modifications and variations are possible in light of the above teachings. The exemplary embodiments were chosen and described to explain certain principles of the present invention and their practical application, to enable others skilled in the art to make and utilize various exemplary embodiments of the present invention, as well as various alternatives and modifications thereof. It is intended that the scope of the present invention be defined by the Claims appended hereto and their equivalents.

What is claimed is:

1. An apparatus of controlling a fuel pump of a hybrid electric vehicle using an engine and a motor as driving power sources, the apparatus comprising:
the fuel pump including a fuel pump motor and configured to supply a fuel to the engine according to operation of the fuel pump motor;
an engine controller configured to turn on a fuel pump relay controlling an electric connection between the fuel pump motor and a power supply upon determining that the engine is started; and
a fuel pump controller configured to be turned on by electric power received from the power supply when the fuel pump relay is turned on by the engine controller, and to stop operation of the fuel pump by stopping supply of the electric power applied to the fuel pump motor upon determining that the engine is stopped after starting the engine.

2. The apparatus of claim 1, wherein, when the fuel pump controller stops the supply of the electric power applied to the fuel pump motor, the fuel pump relay is configured to maintain an on-state thereof.

3. The apparatus of claim 1, wherein the engine controller is configured to turn off the fuel pump relay upon determining that the engine is turned off.

4. The apparatus of claim 1, wherein the fuel pump controller is configured to drive the fuel pump for a predetermined time period, upon determining that an accumulated driving distance of the hybrid electric vehicle after starting the engine is less than or equal to a predetermined threshold distance.

5. The apparatus of claim 4, wherein the fuel pump controller is configured to control a pressure of the fuel discharged from the fuel pump so that an actually measured fuel pressure in a fuel line connecting the fuel pump and the engine follows a target fuel pressure, upon determining that the accumulated driving distance of the hybrid electric vehicle after starting the engine exceeds the predetermined threshold distance.

6. The apparatus of claim 1, wherein the fuel pump controller is configured to drive or stop the fuel pump by controlling the electric power applied to the fuel pump motor according to engine status information received from the engine controller after starting the engine.

7. The apparatus of claim 6, wherein, when the hybrid electric vehicle enters an electric vehicle mode, in which the engine is stopped and the motor alone is driven as the driving power source, after starting the engine, the fuel pump controller is configured to stop operation of the fuel pump after a predetermine time elapses.

8. The apparatus of claim 7, wherein the fuel pump controller is configured to control a pressure of the fuel discharged from the fuel pump to a predetermined reference pressure value, upon determining that the engine status information or target fuel pressure information is not received from the engine controller while the hybrid electric vehicle is being driven in the electric vehicle mode.

9. The apparatus of claim 7, wherein the fuel pump controller is configured to drive the fuel pump, upon determining that a residual pressure in a fuel line connecting the fuel pump and the engine is less than a predetermined threshold pressure while the hybrid electric vehicle is driven in the electric vehicle mode.

10. The apparatus of claim 6, wherein the fuel pump controller is configured to drive the fuel pump by applying the electric power to the fuel pump motor, upon determining that the engine transitions from a stop mode to a non-stop mode.

11. The apparatus of claim 6, wherein the fuel pump controller is configured to control a pressure of the fuel discharged from the fuel pump to a predetermined reference pressure value, until the engine status information is received from the engine controller while the engine is being driven.

12. A method of controlling a fuel pump of a hybrid electric vehicle using an engine and a motor as driving power sources, the method comprising:
turning on, by an engine controller, a fuel pump relay controlling an electric connection between a fuel pump motor of the fuel pump and a power supply upon determining that the engine is started; and
turning on, by the engine controller, a fuel pump controller by turning on the fuel pump relay connected to the fuel pump controller,
wherein the fuel pump controller is configured to stop operation of the fuel pump by turning off the fuel pump relay upon determining that the engine is stopped after starting the engine,
wherein the fuel pump includes the fuel pump motor and configured to supply a fuel to the engine according to operation of the fuel pump motor, and
wherein the fuel pump controller is connected between the fuel pump relay and the fuel pump.

13. The method of claim 12, wherein, when the fuel pump controller stops the supply of an electric power applied to the fuel pump motor, the fuel pump relay is configured to maintain an on-state thereof.

14. The method of claim 12, further including:
turning off, by the engine controller, the fuel pump relay upon determining that the engine is turned off.

15. The method of claim 12, further including:
driving, by the fuel pump controller, the fuel pump for a predetermined time period, upon determining that an accumulated driving distance of the hybrid electric vehicle after starting the engine is less than or equal to a predetermined threshold distance; and
controlling, by the fuel pump controller, a pressure of the fuel discharged from the fuel pump so that an actually measured fuel pressure in a fuel line connecting the fuel pump and the engine follows a target fuel pressure, upon determining that the accumulated driving distance of the hybrid electric vehicle after starting the engine exceeds the predetermined threshold distance.

16. The method of claim 12, further including:
driving or stopping, by the fuel pump controller, the fuel pump by controlling an electric power applied to the fuel pump motor according to engine status information received from the engine controller after starting the engine.

17. The method of claim 16, further including:
stopping, by the fuel pump controller, operation of the fuel pump after a predetermine time elapses, when the hybrid electric vehicle enters an electric vehicle mode, in which the engine is stopped and the motor alone is driven as the driving power source, after starting the engine,

18. The method of claim 17, further including:
controlling, by the fuel pump controller, a pressure of the fuel discharged from the fuel pump to a predetermined reference pressure value, upon determining that the engine status information or target fuel pressure information is not received from the engine controller while the hybrid electric vehicle is driven in the electric vehicle mode.

19. The method of claim 17, further including:
driving, by the fuel pump controller, the fuel pump, upon determining that a residual pressure in a fuel line connecting the fuel pump and the engine is less than a predetermined threshold pressure while the hybrid electric vehicle is driven in the electric vehicle mode.

20. The method of claim 16, further including:
driving, by the fuel pump controller, the fuel pump by applying the electric power to the fuel pump motor, upon determining that the engine transitions from a stop mode to a non-stop mode.

21. The method of claim 16, further including:
controlling, by the fuel pump controller, a pressure of the fuel discharged from the fuel pump to a predetermined reference pressure value, until the engine status information is received from the engine controller while the engine is driven.
